(19) United States
(12) Patent Application Publication
(10) Pub. No.: US 2026/0122280 A1
(43) Pub. Date: Apr. 30, 2026

(54) A CODING METHOD OR APPARATUS SIGNALING AN INDICATION OF CAMERA PARAMETERS

(71) Applicant: InterDigital CE Patent Holdings, SAS, Paris (FR)

(72) Inventors: Saurabh Puri, Saint-Lazare (CA); Sylvain Thiebaud, Noyal sur Vilaine (FR); Tangi Poirier, Thorigne-Fouillard (FR); Karam Naser, Mouaze (FR)

(21) Appl. No.: 19/149,801

(22) PCT Filed: Jan. 16, 2024
(86) PCT No.: PCT/EP2024/050915

§ 371 Date: Jul. 21, 2025

(30) Foreign Application Priority Data
Jan. 20, 2023 (EP) 23305071.5

(51) Int. Cl. H04N 19/70; H04N 19/463; H04N 19/52; H04N 19/593

(52) U.S. Cl. CPC H04N 19/70; H04N 19/463; H04N 19/52; H04N 19/593

(57) ABSTRACT

At least a method and an apparatus are presented for efficiently encoding or decoding video. For example, a syntax data element (sps_camera_param_enabled_flag) is added to a bitstream, the syntax data element indicating whether a camera parameters syntax structure (gaming_camera_data) is present in a bitstream; and responsively, at least one camera parameters syntax data structure (gaming_camera_data) is added to the bitstream at a picture level, the data syntax structure representing camera parameters that provide information of a position, an orientation and characteristics of a game engine virtual camera capturing a picture. The camera parameters are utilized in the encoding or decoding of a rendered 2D picture of a 3D scene.

### CROSS REFERENCE TO RELATED APPLICATIONS

This application claims the benefit of European Patent Application No. 23305071.5, filed on Jan. 20, 2023, which is incorporated herein by reference in its entirety.

### TECHNICAL FIELD

At least one of the present embodiments generally relates to a method or an apparatus for video encoding or decoding, and more particularly, to a method or an apparatus comprising encoding/decoding camera parameters that provide information of a position, an orientation and characteristics of a game engine virtual camera capturing a picture.

### BACKGROUND

To achieve high compression efficiency, image and video coding schemes usually employ prediction, including motion vector prediction, and transform to leverage spatial and temporal redundancy in the video content. Generally, intra or inter prediction is used to exploit the intra or inter frame correlation, then the differences between the original image and the predicted image, often denoted as prediction errors or prediction residuals, are transformed, quantized, and entropy coded. To reconstruct the video, the compressed data are decoded by inverse processes corresponding to the entropy coding, quantization, transform, and prediction.

To obtain coding gains, modern codec standards define more and more sophisticated tools, and let the codec encoder decide the best ones to use. In the scope of cloud gaming compression, minimizing the latency is key. Although intensive computation capabilities are required in recent encoders that introduce a latency between the rendering of the game content and its coding.

Existing methods for coding and decoding show some limitations in the domain of coding 2D rendered video of a game engine. Therefore, there is a need to improve the state of the art.

### SUMMARY

The drawbacks and disadvantages of the prior art are solved and addressed by the general aspects described herein.

According to a first aspect, there is provided a method. The method comprises video encoding a syntax data element indicating whether a camera parameters syntax structure is present in a bitstream; and responsive to the camera parameters syntax structure being present, encoding at least one camera parameters syntax data structure representative of camera parameters at a picture level, wherein the camera parameters provide information of a position, an orientation and characteristics of a game engine virtual camera capturing a picture.

According to another aspect, there is provided a second method. The method comprises video decoding a syntax data element indicating whether a camera parameters syntax structure is present in a bitstream; and responsive to the camera parameters syntax structure being present, decoding at least one camera parameters syntax data structure representative of camera parameters at a picture level, wherein the camera parameters provide information of a position, an orientation and characteristics of a game engine virtual camera capturing a picture.

According to another aspect, there is provided an apparatus. The apparatus comprises one or more processors, wherein the one or more processors are configured to implement the method for video encoding according to any of its variants. According to another aspect, the apparatus for video encoding comprises means for implementing the method for video decoding according to any of its variants.

According to another aspect, there is provided another apparatus. The apparatus comprises one or more processors, wherein the one or more processors are configured to implement the method for video decoding according to any of its variants. According to another aspect, the apparatus for video decoding comprises means for implementing the method for video decoding according to any of its variants.

According to another general aspect of at least one embodiment, there is provided a device comprising an apparatus according to any of the decoding embodiments; and at least one of (i) an antenna configured to receive a signal, the signal including the video block, (ii) a band limiter configured to limit the received signal to a band of frequencies that includes the video block, or (iii) a display configured to display an output representative of the video block.

According to another general aspect of at least one embodiment, there is provided a non-transitory computer readable medium containing data content generated according to any of the described encoding embodiments or variants.

According to another general aspect of at least one embodiment, there is provided a signal comprising video data generated according to any of the described encoding embodiments or variants.

According to another general aspect of at least one embodiment, a bitstream is formatted to include data content generated according to any of the described encoding embodiments or variants.

According to another general aspect of at least one embodiment, there is provided a computer program product comprising instructions which, when the program is executed by a computer, cause the computer to carry out any of the described encoding/decoding embodiments or variants.

These and other aspects, features and advantages of the general aspects will become apparent from the following detailed description of exemplary embodiments, which is to be read in connection with the accompanying drawings.

### BRIEF DESCRIPTION OF THE DRAWINGS

In the drawings, examples of several embodiments are illustrated.

FIG. 1 illustrates a block diagram of an example apparatus in which various aspects of the embodiments may be implemented.

FIG. 2 illustrates a block diagram of an embodiment of video encoder in which various aspects of the embodiments may be implemented.

FIG. 3 illustrates a block diagram of an embodiment of video decoder in which various aspects of the embodiments may be implemented.

FIG. 4 illustrates an example architecture of a cloud gaming system in which various aspects of the embodiments may be implemented.

FIG. 5 illustrates principles of a pinhole camera model of a virtual camera in a cloud gaming system.

FIG. 6 illustrates projection planes of a virtual camera in a cloud gaming system.

FIG. 7 illustrates a generic encoding method according to a general aspect of at least one embodiment.

FIG. 8 illustrates a generic decoding method according to a general aspect of at least one embodiment.

### DETAILED DESCRIPTION

Various embodiments relate to a video coding system in which, in at least one embodiment, it is proposed to adapt video coding tools to the cloud gaming system. Different embodiments are proposed hereafter, introducing some tools modifications to increase coding efficiency and improve the codec consistency when processing 2D rendered game engine video. Amongst others, an encoding method, a decoding method, an encoding apparatus, a decoding apparatus based on this principle are proposed. Although the present embodiments are presented in the context of the cloud gaming system, they may apply to any system where a 2D video may be associated to with camera parameters, such as a video captured by mobile device along with sensor's information allowing to determine the position and characteristics of the device's camera capturing the video.

Moreover, the present aspects, although describing principles related to particular drafts of VVC (Versatile Video Coding) or to HEVC (High Efficiency Video Coding) specifications, or to ECM (Enhanced Compression Model) reference software are not limited to VVC or HEVC or ECM, and can be applied, for example, to other standards and recommendations, whether pre-existing or future-developed, and extensions of any such standards and recommendations (including VVC and HEVC and ECM). Unless indicated otherwise, or technically precluded, the aspects described in this application can be used individually or in combination.

The acronyms used herein are reflecting the current state of video coding developments and thus should be considered as examples of naming that may be renamed at later stages while still representing the same techniques.

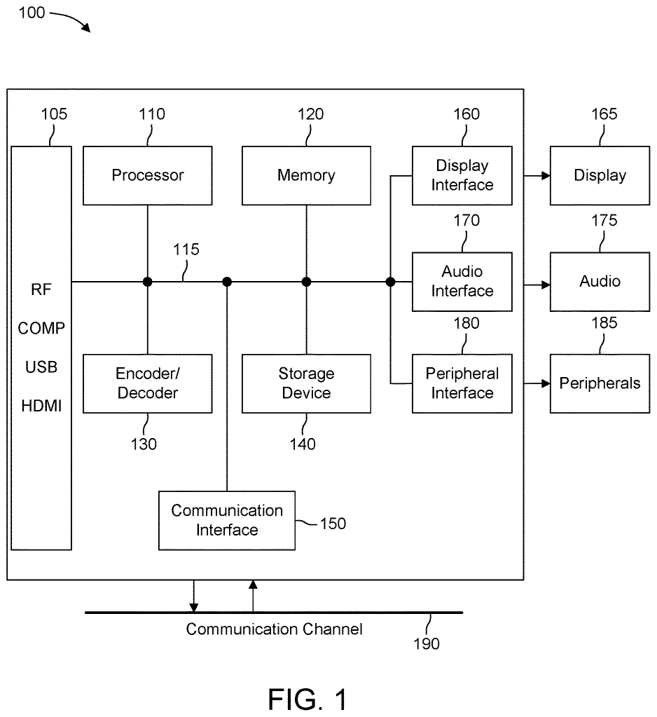

FIG. 1 illustrates a block diagram of an example of a system in which various aspects and embodiments can be implemented. System 100 may be embodied as a device including the various components described below and is configured to perform one or more of the aspects described in this application. Examples of such devices, include, but are not limited to, various electronic devices such as personal computers, laptop computers, smartphones, tablet computers, digital multimedia set top boxes, digital television receivers, personal video recording systems, connected home appliances, and servers. Elements of system 100, singly or in combination, may be embodied in a single integrated circuit, multiple ICs, and/or discrete components. For example, in at least one embodiment, the processing and encoder/decoder elements of system 100 are distributed across multiple ICs and/or discrete components. In various embodiments, the system 100 is communicatively coupled to other systems, or to other electronic devices, via, for example, a communications bus or through dedicated input and/or output ports. In various embodiments, the system 100 is configured to implement one or more of the aspects described in this application.

The system 100 includes at least one processor 110 configured to execute instructions loaded therein for implementing, for example, the various aspects described in this application. Processor 110 may include embedded memory, input output interface, and various other circuitries as known in the art. The system 100 includes at least one memory 120 (e.g. a volatile memory device, and/or a non-volatile memory device). System 100 includes a storage device 140, which may include non-volatile memory and/or volatile memory, including, but not limited to, EEPROM, ROM, PROM, RAM, DRAM, SRAM, flash, magnetic disk drive, and/or optical disk drive. The storage device 140 may include an internal storage device, an attached storage device, and/or a network accessible storage device, as non-limiting examples.

System 100 includes an encoder/decoder module 130 configured, for example, to process data to provide an encoded video or decoded video, and the encoder/decoder module 130 may include its own processor and memory. The encoder/decoder module 130 represents module(s) that may be included in a device to perform the encoding and/or decoding functions. As is known, a device may include one or both of the encoding and decoding modules. Additionally, encoder/decoder module 130 may be implemented as a separate element of system 100 or may be incorporated within processor 110 as a combination of hardware and software as known to those skilled in the art.

Program code to be loaded onto processor 110 or encoder/decoder 130 to perform the various aspects described in this application may be stored in storage device 140 and subsequently loaded onto memory 120 for execution by processor 110. In accordance with various embodiments, one or more of processor 110, memory 120, storage device 140, and encoder/decoder module 130 may store one or more of various items during the performance of the processes described in this application. Such stored items may include, but are not limited to, the input video, the decoded video or portions of the decoded video, the bitstream, matrices, variables, and intermediate or final results from the processing of equations, formulas, operations, and operational logic.

In several embodiments, memory inside of the processor 110 and/or the encoder/decoder module 130 is used to store instructions and to provide working memory for processing that is needed during encoding or decoding. In other embodiments, however, a memory external to the processing device (for example, the processing device may be either the processor 110 or the encoder/decoder module 130) is used for one or more of these functions. The external memory may be the memory 120 and/or the storage device 140, for example, a dynamic volatile memory and/or a non-volatile flash memory. In several embodiments, an external non-volatile flash memory is used to store the operating system of a television. In at least one embodiment, a fast external dynamic volatile memory such as a RAM is used as working memory for video coding and decoding operations, such as for HEVC, or VVC.

The input to the elements of system 100 may be provided through various input devices as indicated in block 105. Such input devices include, but are not limited to, (i) an RF portion that receives an RF signal transmitted, for example, over the air by a broadcaster, (ii) a Composite input terminal, (iii) a USB input terminal, and/or (iv) an HDMI input terminal.

In various embodiments, the input devices of block 105 have associated respective input processing elements as known in the art. For example, the RF portion may be associated with elements suitable for (i) selecting a desired frequency (also referred to as selecting a signal, or band-limiting a signal to a band of frequencies), (ii) down converting the selected signal, (iii) band-limiting again to a narrower band of frequencies to select (for example) a signal frequency band which may be referred to as a channel in certain embodiments, (iv) demodulating the down converted and band-limited signal, (v) performing error correction, and (vi) demultiplexing to select the desired stream of data packets. The RF portion of various embodiments includes one or more elements to perform these functions, for example, frequency selectors, signal selectors, band-limiters, channel selectors, filters, downconverters, demodulators, error correctors, and demultiplexers. The RF portion may include a tuner that performs various of these functions, including, for example, down converting the received signal to a lower frequency (for example, an intermediate frequency or a near-baseband frequency) or to baseband. In one set-top box embodiment, the RF portion and its associated input processing element receives an RF signal transmitted over a wired (for example, cable) medium, and performs frequency selection by filtering, down converting, and filtering again to a desired frequency band. Various embodiments rearrange the order of the above-described (and other) elements, remove some of these elements, and/or add other elements performing similar or different functions. Adding elements may include inserting elements in between existing elements, for example, inserting amplifiers and an analog-to-digital converter. In various embodiments, the RF portion includes an antenna.

Additionally, the USB and/or HDMI terminals may include respective interface processors for connecting system 100 to other electronic devices across USB and/or HDMI connections. It is to be understood that various aspects of input processing, for example, Reed-Solomon error correction, may be implemented, for example, within a separate input processing IC or within processor 110 as necessary. Similarly, aspects of USB or HDMI interface processing may be implemented within separate interface ICs or within processor 110 as necessary. The demodulated, error corrected, and demultiplexed stream is provided to various processing elements, including, for example, processor 110, and encoder/decoder 130 operating in combination with the memory and storage elements to process the datastream as necessary for presentation on an output device.

Various elements of system 100 may be provided within an integrated housing, Within the integrated housing, the various elements may be interconnected and transmit data therebetween using suitable connection arrangement 115, for example, an internal bus as known in the art, including the I2C bus, wiring, and printed circuit boards.

The system 100 includes communication interface 150 that enables communication with other devices via communication channel 190. The communication interface 150 may include, but is not limited to, a transceiver configured to transmit and to receive data over communication channel 190. The communication interface 150 may include, but is not limited to, a modem or network card and the communication channel 190 may be implemented, for example, within a wired and/or a wireless medium.

Data is streamed to the system 100, in various embodiments, using a Wi-Fi network such as IEEE 802.11. The Wi-Fi signal of these embodiments is received over the communications channel 190 and the communications interface 150 which are adapted for Wi-Fi communications. The communications channel 190 of these embodiments is typically connected to an access point or router that provides access to outside networks including the Internet for allowing streaming applications and other over-the-top communications. Other embodiments provide streamed data to the system 100 using a set-top box that delivers the data over the HDMI connection of the input block 105. Still other embodiments provide streamed data to the system 100 using the RF connection of the input block 105.

The system 100 may provide an output signal to various output devices, including a display 165, speakers 175, and other peripheral devices 185. The other peripheral devices 185 include, in various examples of embodiments, one or more of a stand-alone DVR, a disk player, a stereo system, a lighting system, and other devices that provide a function based on the output of the system 100. In various embodiments, control signals are communicated between the system 100 and the display 165, speakers 175, or other peripheral devices 185 using signaling such as AV. Link, CEC, or other communications protocols that enable device-to-device control with or without user intervention. The output devices may be communicatively coupled to system 100 via dedicated connections through respective interfaces 160, 170, and 180. Alternatively, the output devices may be connected to system 100 using the communications channel 190 via the communications interface 150. The display 165 and speakers 175 may be integrated in a single unit with the other components of system 100 in an electronic device, for example, a television. In various embodiments, the display interface 160 includes a display driver, for example, a timing controller (T Con) chip.

The display 165 and speaker 175 may alternatively be separate from one or more of the other components, for example, if the RF portion of input 105 is part of a separate set-top box. In various embodiments in which the display 165 and speakers 175 are external components, the output signal may be provided via dedicated output connections, including, for example, HDMI ports, USB ports, or COMP outputs.

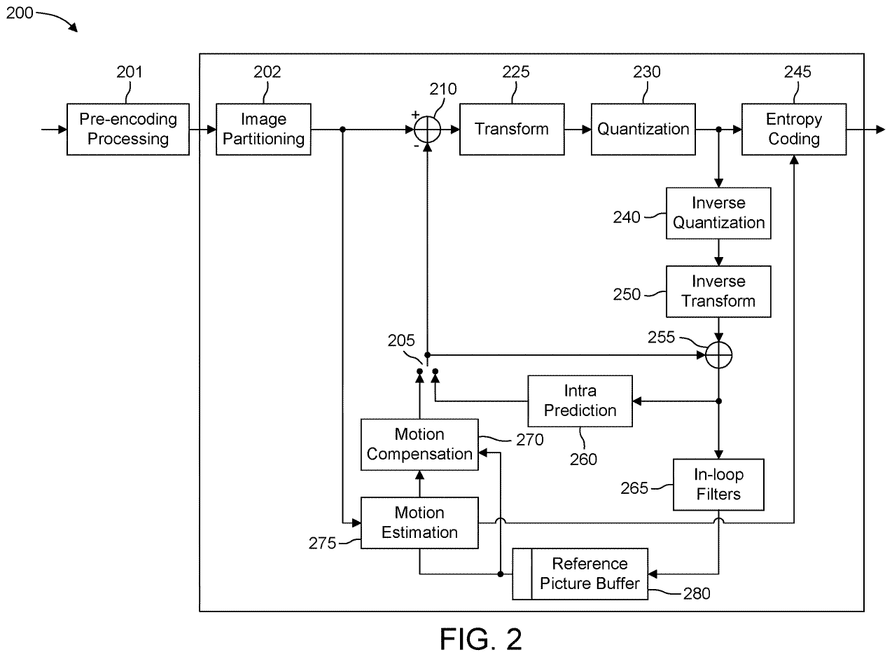

FIG. 2 illustrates an example video encoder 200, such as VVC (Versatile Video Coding) encoder. FIG. 2 may also illustrate an encoder in which improvements are made to the VVC standard or an encoder employing technologies similar to VVC.

In the present application, the terms “reconstructed” and “decoded” may be used interchangeably, the terms “encoded” or “coded” may be used interchangeably, and the terms “image,” “picture” and “frame” may be used interchangeably. Usually, but not necessarily, the term “reconstructed” is used at the encoder side while “decoded” is used at the decoder side. Before being encoded, the video sequence may go through pre-encoding processing (201), for example, applying a color transform to the input color picture (e.g., conversion from RGB 4:4:4 to YCbCr 4:2:0), or performing a remapping of the input picture components in order to get a signal distribution more resilient to compression (for instance using a histogram equalization of one of the color components). Metadata can be associated with the pre-processing, and attached to the bitstream.

In the encoder 200, a picture is encoded by the encoder elements as described below. The picture to be encoded is partitioned (202) and processed in units of, for example, CUs. Each unit is encoded using, for example, either an intra or inter mode. When a unit is encoded in an intra mode, it performs intra prediction (260). In an inter mode, motion estimation (275) and compensation (270) are performed. The encoder decides (205) which one of the intra mode or inter mode to use for encoding the unit, and indicates the intra/inter decision by, for example, a prediction mode flag. Prediction residuals are calculated, for example, by subtracting (210) the predicted block from the original image block.

The prediction residuals are then transformed (225) and quantized (230). The quantized transform coefficients, as well as motion vectors and other syntax elements, are entropy coded (245) to output a bitstream. The encoder can skip the transform and apply quantization directly to the non-transformed residual signal. The encoder can bypass both transform and quantization, i.e., the residual is coded directly without the application of the transform or quantization processes.

The encoder decodes an encoded block to provide a reference for further predictions. The quantized transform coefficients are de-quantized (240) and inverse transformed (250) to decode prediction residuals. Combining (255) the decoded prediction residuals and the predicted block, an image block is reconstructed. In-loop filters (265) are applied to the reconstructed picture to perform, for example, deblocking/SAO (Sample Adaptive Offset) filtering to reduce encoding artifacts. The filtered image is stored at a reference picture buffer (280).

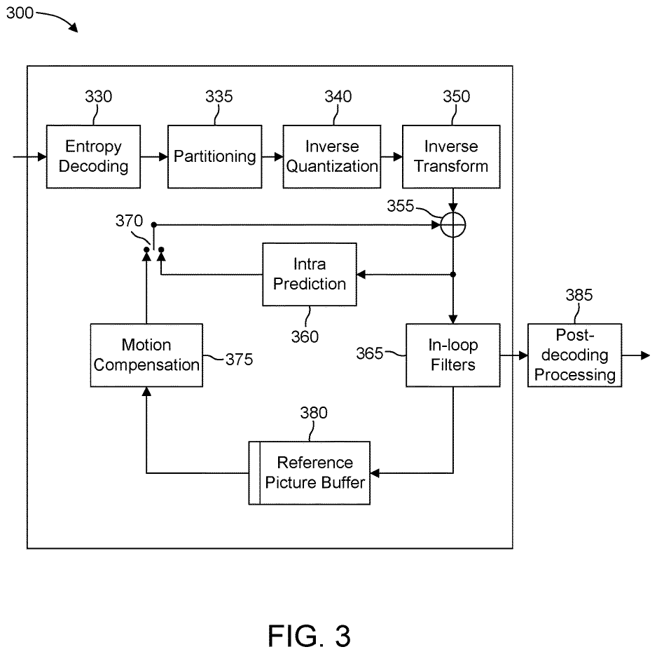

FIG. 3 illustrates a block diagram of an example video decoder 300. In the decoder 300, a bitstream is decoded by the decoder elements as described below. Video decoder 300 generally performs a decoding pass reciprocal to the encoding pass as described in FIG. 2. The encoder 200 also generally performs video decoding as part of encoding video data.

In particular, the input of the decoder includes a video bitstream, which can be generated by video encoder 200. The bitstream is first entropy decoded (330) to obtain transform coefficients, motion vectors, and other coded information. The picture partition information indicates how the picture is partitioned. The decoder may therefore divide (335) the picture according to the decoded picture partitioning information. The transform coefficients are de-quantized (340) and inverse transformed (350) to decode the prediction residuals. Combining (355) the decoded prediction residuals and the predicted block, an image block is reconstructed. The predicted block can be obtained (370) from intra prediction (360) or motion-compensated prediction (i.e., inter prediction) (375). In-loop filters (365) are applied to the reconstructed image. The filtered image is stored at a reference picture buffer (380). The decoded picture can further go through post-decoding processing (385), for example, an inverse color transform (e.g., conversion from YCbCr 4:2:0 to RGB 4:4:4) or an inverse remapping performing the inverse of the remapping process performed in the pre-encoding processing (201). The post-decoding processing can use metadata derived in the pre-encoding processing and signaled in the bitstream.

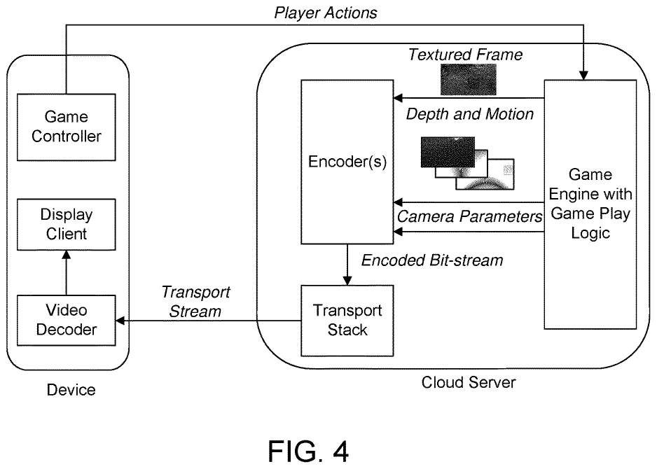

FIG. 4 shows an example architecture of a cloud gaming system, where a game engine may be running on a cloud server. The gaming system may render a game scene based on the player actions. The rendered game scene may be represented as a 2D video including a set of texture frames. The rendered game engine 2D video may be encoded into a bitstream, for example, using a video encoder. The bitstream may be encapsulated by a transport protocol and may be sent as a transport stream to the player's device. The player's device may de-encapsulate and decode the transport stream and present the decoded 2D video representing the game scene to the player. As illustrated in FIG. 4, additional information such as a depth information, motion information, an object ID, an occlusion mask, or camera parameters, etc. may be obtained from a game engine (e.g., as outputs of the game engine) and made available to the cloud server (e.g., an encoder of the cloud) as prior information.

The information described herein such as the depth information, or motion information, or camera parameters or a combination thereof may be utilized to improve the encoding the rendered game engine 2D video in a video processing device (e.g., the encoder side of a video codec). At least one embodiment relates to the signaling of camera parameters (for example, obtained for the virtual camera in a 3D scene from the game engine) as high-level syntax contained in the picture header. At least one embodiment proposes adding a camera parameters syntax data structure to transmit some information on the position, the orientation, and the characteristics of the virtual camera of the game engine. Advantageously, these parameters are considered mandatory for the decoder. The camera parameter may be synchronized with the video frames and if they change, they may be updated for each frame. Advantageously, if these parameters remain the same for several consecutive frames, they can be transmitted only once.

In the following, at least one embodiment of a model of a virtual camera in a 3D scene capturing a picture is detailed. According to at least one embodiment, the video to encode is generated by 3D game engine as shown in the cloud gaming system of FIG. 4. Thus, the picture is part of a game engine 2D rendered video. However, the present principles are not limited to a signaling virtual camera parameters in a cloud gaming system and may apply to any parameters of a camera used to a 2D video of a 3D scene.

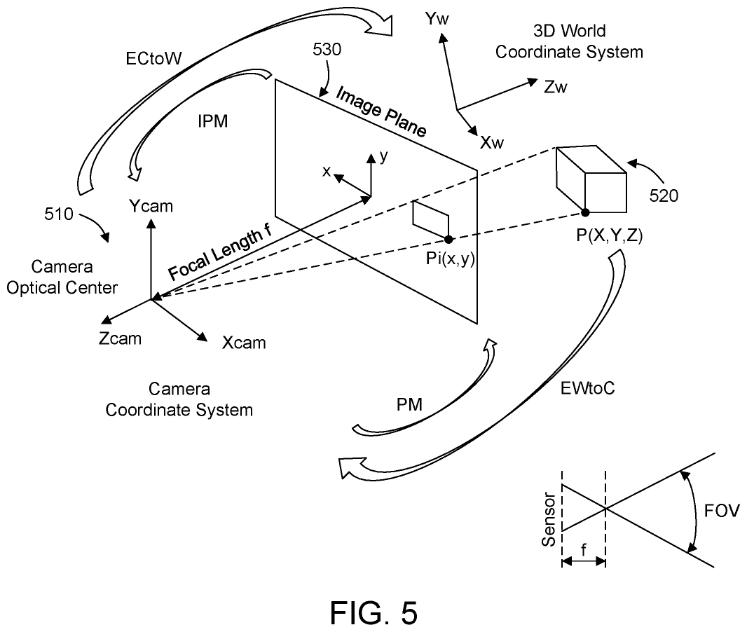

FIG. 5 illustrates principles of a pinhole camera model of a virtual camera in a cloud gaming system. The 3D engine uses a virtual camera 510 to project the 3D scene 520 onto a plane 530 to generate a 2D image. In the pinhole camera representation, the physical characteristics of the camera (focal length f, sensor size, field of view FOV, . . . ) may be used to compute a projection matrix, which is the intrinsic matrix of the camera. This matrix defines a point Pi(x,y) in the 2D image where a point P(X, Y, Z) in the 3D space is projected. In the following, the matrix is referred to as the camera projection matrix or intrinsic matrix and the 2D image as a game engine 2D rendered image. The position of the 3D objects P(X, Y, Z) in the 3D world is known relative to the 3D world coordinate system. However, the camera performs its projection relative to its own coordinate system, the camera coordinate system in FIG. 5. Since the gamer can move around the 3D world, the virtual camera is not fixed at the origin of the 3D world. It means that before applying the camera projection of a 3D point P(X, Y, Z) (known relatively to the 3D world coordinate system), this point is mapped in the camera coordinate system. This mapping is performed thanks to a “world to camera” matrix EWtoC in FIG. 5. This matrix represents the rotations and the translations of the camera relatively to the 3D world coordinate system. The inverse transformation is the “camera to world” matrix ECtoW in FIG. 5. These 2 matrices are also called the extrinsic matrices of the camera.

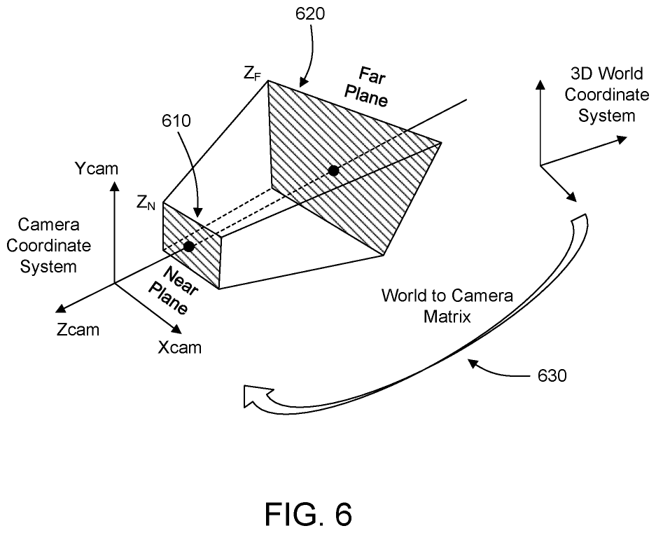

FIG. 6 illustrates projection planes of a virtual camera in a cloud gaming system. Indeed, unlike physical cameras that project objects distant from 0 to infinity, a virtual camera of a game engine projects the objects in between two projection planes: a near plane 610 and a far plane 620. It means that these two planes represent the minimal and maximal depth used for the rendering: the near plane 610 is usually mapped to depth 0 and the far plane 620 to depth 1. However, according to a variant, the depth value associated with the far and near plane may be represented conversely. The camera projection matrix depends on the position of the planes 610, 620. The way this matrix is built is described in the following. Computations are usually performed in homogeneous coordinates, with a 4 by 4 projection matrix. In a variant, a game engine provides the 16 coefficients of the projection matrix used to perform the rendering.

Alternatively, some parameters can be extracted from the game engine, to compute these matrix coefficients. For instance, a projection matrix can be computed as below:

$$PM = I = [ \begin{matrix}\frac{1}{tan ( \frac{FoV}{2} )} \cdot \frac{H}{V} & 0 & 0 & 0 \\ 0 & \frac{1}{tan ( \frac{FoV}{2} )} & 0 & 0 \\ 0 & 0 & - \frac{{Z}_{F} + {Z}_{N}}{{Z}_{F} - {Z}_{N}} & - \frac{2 {Z}_{F} {Z}_{N}}{{Z}_{F} - {Z}_{N}} \\ 0 & 0 & - 1 & 0\end{matrix} ]$$

where FoV represents the vertical Field of View.

H and V represent the width and the height of the picture. Since H/V is the aspect ratio, in a variant, the aspect ratio is used as camera parameter instead of the picture width and high.

Z_{N} and Z_{F} represent the position of the near plane 610 and the far plane 620 as shown in FIG. 6. The Focal Length f, modified when the camera performs a zoom in or a zoom out, does not appear here. In fact, the Focal Length is directly linked to the FoV parameter, as presented in FIG. 5. According to different variants, one or the other can be used to compute the matrix coefficients.

A zoom operation (modification of the focal length or of the field of view) affects only 2 coefficients of the intrinsic matrix:

$$\begin{matrix}IF 0 = \frac{1}{tan ( \frac{F o V}{2} )} . \frac{H}{V} \\ I F 1 = \frac{1}{tan ( \frac{F o V}{2} )}\end{matrix}$$

A modification of the near and far plane position affects only 2 other intrinsic matrix coefficients:

$$\begin{matrix}IP 0 = - \frac{{Z}_{F} + {Z}_{N}}{{Z}_{F} - {Z}_{N}} \\ I P 1 = - \frac{2 {Z}_{F} {Z}_{N}}{{Z}_{F} - {Z}_{N}}\end{matrix}$$

Accordingly, in a variant embodiment, 2 sets of intrinsic matrix coefficients are defined and signaled independently: one set related to the field of view, and one set related to projection planes. In yet another variant, the 2 sets may be updated separately.

According to yet another variant, instead of signaling the coefficient of the intrinsic matrix, the parameters representing the attributes of the rendering such as FoV, near and far plane positions etc. are transmitted to the decoder. In this variant, the intrinsic matrix coefficients are computed by the decoder according to equations of matrix I.

As another alternative embodiment, the 16 matrix coefficients (for example, computed by the encoder or provided by the game engine) of the projection matrix PM are coded separately in the picture header. Advantageously, this variant covers the general case of transmitting any projection matrix.

According to another variant, a game engine provides the 16 coefficients of the World to Camera matrix, referred to as extrinsic matrix. The virtual camera may be placed everywhere in the 3D world, that is not especially at its origin, and according to any orientation. The translations and rotations of the virtual camera in the 3D world coordinate system are represented by the “world to camera” extrinsic matrix EWtoC, or its inverse matrix the “camera to world” matrix ECtoW. In a variant, a game engine provides the 16 coefficients of the extrinsic matrix used to perform the rendering. The way these matrices are computed is not detailed here, but the following 4×4 Translation Scale Rotation (TSR) matrix indicates how it is composed.

TSR matrix composition:

$$EWto C = [ \begin{matrix}{R}_{0} & {R}_{1} & {R}_{2} & {T}_{0} \\ {R}_{3} & {R}_{4} & {R}_{5} & {T}_{1} \\ {R}_{6} & {R}_{7} & {R}_{8} & {T}_{2} \\ 0 & 0 & 0 & 1\end{matrix} ]$$

The 9 Ri (R₀, . . . , R₈) coefficients represent the rotations of the camera around the 3 axes. In a variant, the Ri coefficients are computed with the 3 rotation parameters of the camera (one per axis). The 3 Ti (T₀, T₁, T₂) coefficients represent the translations of the camera relatively to the 3D world origin. Camera translations are more frequent than rotations. Accordingly, in a variant, 2 sets of extrinsic matrix coefficients are defined, one set related to the rotations, and one set related to the translations. In yet another variant, the 2 sets may be updated separately thus allowing modifying the translation parameters independently from the rotation parameters.

As presented before, the translation parameters provided by the game engine correspond to the translation of the camera system coordinate relative to the 3D world system coordinate. This translation can be quite important since its maximum value corresponds to the size of the game's 3D world and is not known (except by the game designer who knows the size of its 3D world). Accordingly, in a variant, the translation of the camera is indicated relatively to its previous position (its displacement or a difference of position is indicated) instead of its absolute translation relatively to the 3D world.

According to a generic embodiment, at least one camera parameters syntax data structure representative of camera parameters is signaled at a picture level, the camera parameters providing information on a position, an orientation and characteristics of a game engine virtual camera capturing a picture. Advantageously, information on a position, an orientation of the camera is provided as a set of intrinsic matrix coefficients while information on characteristics of the camera is provided by a set of extrinsic matrix coefficients. Thus, the game engine is able to project a 3D point to a 2D image point, and conversely. To project a 3D point to a 2D image, both the (extrinsic) “world to camera” matrix and the (intrinsic) camera projection matrix are needed. Conversely, to find the 3D position of a 2D image point, the inverse camera projection matrix and the “camera to world” matrix are needed. This “camera to world” matrix is the inverse matrix of the “world to camera” matrix. As shown in FIG. 5, 4 matrices, namely inverse intrinsic projection matrix [PM]⁻¹, extrinsic camera to world matrix [ECtoW], the extrinsic world to camera matrix [EWtoC] and the intrinsic projection matrix [PM], representative of a change of coordinate system or projection/deprojection are used to convert a 3D point into a 2D point and conversely.

According to different variant embodiments described in the following with a non-limiting example of camera parameters semantics, all this information can be transmitted to the decoder in absolute value (real rotation and translation relatively to the 3D world coordinate system) or in relative value, for instance the rotation and the translation of the camera of picture n relatively to its position at picture n−1.

Some parameters may be transmitted, others may be inferred at the decoder side. For instance, if the “world to camera” translation is transmitted, the “camera to world” translation is the opposite translation. If an intrinsic or extrinsic matrix is transmitted, a decoder having computing capabilities may for instance compute the inverse matrix. In a variant, a flag is signaled indicating that inverse matrix is not signaled and needs to be computed at the decoder. In another variant, a single flag is used, for example, to indicate the presence or absence of inverse intrinsic and/or extrinsic matrix in the bitstream. Alternatively, a separate flag is signaled to indicate the presence or absence of each element of intrinsic or extrinsic matrix.

At least some embodiments relate to method for encoding or decoding a video with a syntax data element indicating whether a camera parameters syntax structure is present in a bitstream; and wherein responsive to the camera parameters syntax structure being present, the bitstream further comprises at least one camera parameters syntax data structure representative of camera parameters at a picture level, wherein the camera parameters provide information of a position, an orientation and characteristics of a game engine virtual camera capturing a picture. Advantageously, this information on camera parameters may be used by the encoder to make encoding decision, improve coding efficiency and optionally transmitted to the decoder.

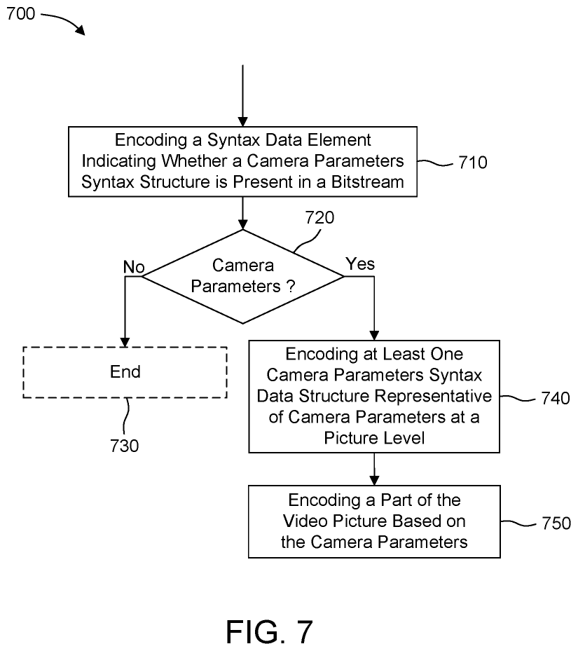

FIG. 7 illustrates a generic encoding method 700 according to a general aspect of at least one embodiment. The block diagram of FIG. 7 partially represents modules of an encoder or encoding method, for instance implemented in the exemplary encoder of FIG. 4 or of FIG. 2.

According to a preliminary step not shown on FIG. 7, a game engine may generate at least one picture (texture image) of a 2D video, the rendered game engine 2D video, along with side information. According to non-limiting examples, side information may comprise camera parameters of the virtual camera capturing the game scene. According to a first step 710, a syntax data element (sps_camera_param_enabled_flag) indicating whether a camera parameters syntax structure (gaming_camera_data) is present in a bitstream is coded. This syntax data element may be signaled at sequence level, for instance in a SPS. In a step 720, the syntax data element is tested. Responsive to the camera parameters syntax structure being present (yes), the method further comprises, at a picture level, an encoding step 740 of at least one camera parameters syntax data structure (gaming_camera_data) representative of camera parameters, wherein the camera parameters provide information of a position, an orientation and characteristics of a game engine virtual camera capturing a picture. Responsive to the camera parameters syntax structure not being present (no), the method ends 730. According to yet another optional step, the at least a part of the picture of a 2D video is encoded using camera parameters to improve the encoding efficiency.

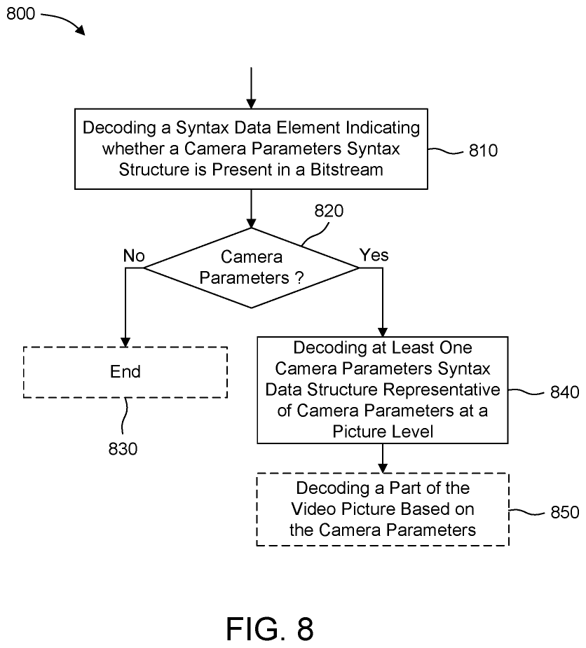

FIG. 8 illustrates a generic decoding method 800 according to a general aspect of at least one embodiment. The block diagram of FIG. 8 partially represents modules of a decoder or decoding method, for instance implemented in the exemplary decoder of FIG. 4 or of FIG. 3. According to preliminary steps not shown on FIG. 8, a coded bitstream is received that carries data representative of at least one picture (texture image) of a 2D video, the rendered game engine 2D video, along with side information. According to non-limiting examples, side information may comprise camera parameters of the virtual camera capturing the game scene. According to a first step 810, a syntax data element (sps_camera_param_enabled_flag) indicating whether a camera parameters syntax structure (gaming_camera_data) is present in a bitstream is decoded. In a step 820, the syntax data element is tested. Responsive to the camera parameters syntax structure being present (yes), the method further comprises, at a picture level, a decoding step 840 of at least one camera parameters syntax data structure (gaming_camera_data) representative of camera parameters, wherein the camera parameters provide information on a position, an orientation or characteristics of a game engine virtual camera capturing a picture. Responsive to the camera parameters syntax structure not being present (no), the method ends 830. According to yet another optional step 850, the at least a part of the picture of the 2D video is decoded using decoded camera parameters.

### Various Embodiments of the Generic Encoding or Decoding Method are Described in the Following.

According to at least one embodiment, a syntax data element indicates whether a camera parameters syntax structure is present in a bitstream. For instance, a high-level flag (sps_camera_param_enabled_flag) is added in sequence parameter set (SPS) to indicate the use of camera parameters on the decoder side, with the following syntax:

```
seq_parameter_set_rbsp ( ) {
  ...
  sps_camera_param_enabled_flag
  ...
}
```

According to at least one embodiment, at least one camera parameters syntax data structure representative of camera parameters is added at a picture level, wherein the camera parameters provide information of a position, an orientation and characteristics of a game engine virtual camera capturing a picture. For instance, the syntax structure gaming_camera_data( ) is added to the picture header corresponding to the game engine's camera parameters, with the following syntax (new syntax structure is shown in bold):

| | Descriptor |
|---|---|
| picture_header_structure( ) { | |
| ph_gdr_or_irap_pic_flag | u(1) |
| ph_non_ref_pic_flag | u(1) |
| if( ph_gdr_or_irap_pic_flag ) | |
| ph_gdr_pic_flag | u(1) |
| ph_inter_slice_allowed_flag | u(1) |
| if( ph_inter_slice_allowed_flag ) | |
| ph_intra_slice_allowed_flag | u(1) |
| ph_pic_parameter_set_id | ue(v) |
| ph_pic_order_cnt_lsb | u(v) |
| if( ph_gdr_pic_flag ) | |
| ph_recovery_poc_cnt | ue(v) |
| for( i = 0; i < NumExtraPhBits; i++ ) | |
| ph_extra_bit[ i ] | u(1) |
| if( sps_poc_msb_cycle_flag ) { | |
| ph_poc_msb_cycle_present_flag | u(1) |
| if( ph_poc_msb_cycle_present_flag ) | |
| ph_poc_msb_cycle_val | u(v) |
| } | |
| if(sps_camera_param_enabled_flag) { | |
| gaming_camera_data( ) | |
| } | |
| ... | |
| if( pps_picture_header_extension_present_flag ) { | |
| ph_extension_length | ue(v) |
| for( i = 0; i < ph_extension_length; i++) | |
| ph_extension_data_byte[ i ] | u(8) |
| } | |
| } | |

According to a particular embodiment, a non-limiting example of the syntax structure is detailed hereafter. In this embodiment, the parameters are separated into intrinsic and extrinsic parameters. In a variant, the extrinsic parameters which are provided to the decoder represent the absolute position of the game engine's camera relative to the 3D world system coordinate.

The syntax of the gaming camera parameters could be defined as:

| | Descriptor |
|---|---|
| gaming_camera_data( ) { | |
| intrinsic_param_focal_flag | u(1) |
| intrinsic_param plane_flag | u(1) |
| extrinsic_param_rotation_flag | u(1) |
| extrinsic_param_translation_flag | u(1) |
| inv_intrinsic_param_focal_flag | u(1) |
| inv_intrinsic_param plane_flag | u(1) |
| inv_extrinsic_param_rotation_flag | u(1) |
| inv_extrinsic_param_translation_flag | u(1) |
| if(intrinsic_param_focal_flag) { | |
| IF0 | FP |
| IF1 | FP |
| } | |
| if(intrinsic_param_plane_flag) { | |
| IP0 | FP |
| IP1 | FP |
| } | |
| if(extrinsic_param_rotation_flag) { | |
| or(j=0; j<3; j++) { | |
| for(k=0;k<3;k++){ | |
| EWtoCR [j][k] | FP |
| } | |
| } | |
| } | |
| if(extrinsic_param_translation_flag) { | |
| for(k=0;k<3;k++){ | |
| EWtoCT[k] | FP |
| } | |
| } | |
| if(inv_intrinsic_param_focal_flag) { | |
| IIF0 | FP |
| IIF1 | FP |
| } | |
| if(inv_intrinsic_param_plane_flag) { | |
| IIP0 | FP |
| IIP1 | FP |
| } | |
| if(inv_extrinsic_param_rotation_flag) { | |
| for(j=0; j<3; j++) { | |
| for(k=0;k<3;k++){ | |
| ECtoWR [j][k] | FP |
| } | |
| } | |
| } | |
| if(inv_extrinsic_param_translation_flag) { | |
| for(k=0;k<3;k++){ | |
| ECtoWT[k] | FP |
| } | |
| } | |

In this syntax table defining the “gaming_camera_data”, the format of the camera parameters is indicated as FP, for Floating Point. The way these parameters are coded may depend on their use. For instance, it can be 32bits floating point as usually represented in C for instance, or double floating point coded with 64 bits. It may also be a dedicated floating-point coding, composed of a sign, a mantissa, and an exponent, where the size of the mantissa depends on a fourth parameter defining the precision. Finally, it can also be coded as a 32-bit integer value instead of floating point.

The semantics of these parameters are:

intrinsic_param_focal_flag: Indicates (when equal to 1) that the first set of intrinsic camera parameter related to the field of view is defined.

intrinsic_param plane_flag: Indicates (when equal to 1) that the second set of intrinsic camera parameter related to the game engine's far and near planes is defined.

extrinsic_param_rotation_flag: Indicates (when equal to 1) that the 9 extrinsic coefficients representing the camera rotation are defined (world to camera extrinsic matrix).

extrinsic_param_translation_flag: Indicates (when equal to 1) that the 3 extrinsic coefficients representing the camera translation are defined.

inv_intrinsic_param_focal_flag: Indicates (when equal to 1) that the first set of inverse intrinsic camera parameter related to the field of view is defined.

inv_intrinsic_param plane_flag: Indicates (when equal to 1) that the second set of inverse intrinsic camera parameter related to the game engine's far and near planes is defined.

inv_extrinsic_param_rotation_flag: Indicates (when equal to 1) that the 9 extrinsic coefficients representing the camera rotation are defined.

inv_extrinsic_param_translation_flag

IF0: Represents the first coefficient of the game engine's intrinsic matrix related to the horizontal field of view, named IF0 in intrinsic matrix I.

Alternatively, in another embodiment this parameter may represent the aspect ratio camera parameter. Associated with the next parameter representing the camera parameter field of view, this parameter can be used to compute the matrix coefficient.

IF1: Represents the second coefficient of the game engine's intrinsic matrix related to the vertical field of view, named IF1 in intrinsic matrix I.

Alternatively, in another embodiment this parameter may represent the field of view camera parameter. Associated with the previous parameter representing the camera aspect ratio, this parameter can be used to compute the 2 first matrix coefficients.

IP0: Represents the first coefficient of the game engine's intrinsic matrix related to the planes position, named IP0 in intrinsic matrix I.

Alternatively, in another embodiment this parameter may represent the near plane position Z_{N} camera parameter. Associated with the next parameter representing the far plane position Z_{F}, this parameter can be used to compute the matrix coefficient.

IP1: Represents the second coefficient of the game engine's intrinsic matrix related to the planes position, named IP1 in intrinsic matrix I.

Alternatively, in another embodiment this parameter may represent the far plane position Z_{F} camera parameter. Associated with the previous parameter representing the near plane position Z_{N}, this parameter can be used to compute the matrix coefficient.

EWtoCR[j][k]: These 9 coefficients represent the rotation part of the extrinsic world to camera matrix.

EWtoCT[k]: These 3 coefficients represent the translation part of the extrinsic world to camera matrix.

IIF0: Represents the first coefficient of the game engine's inverse intrinsic matrix related to the horizontal field of view.

IIF1: Represents the second coefficient of the game engine's inverse intrinsic matrix related to the vertical field of view.

IIP0: Represents the first coefficient of the game engine's inverse intrinsic matrix related to the planes position.

IIP1: Represents the second coefficient of the game engine's inverse intrinsic matrix related to the planes position.

ECtoWR[j][k]: These 9 coefficients represent the rotation part of the extrinsic camera to world matrix.

ECtoWT[k]: These 3 coefficients represent the translation part of the extrinsic camera to world matrix

According to at least one embodiment, an indication that inverse intrinsic matrix coefficients and inverse extrinsic matrix coefficients are computed at a decoder is added to the bitsream. In constrast to the dedicated flag disclosed above for the inverse matrices, in this variant, a single flag is coded to indicate the presence or absence of the inverse matrices. When the flag is set, all the inverse matrix is computed at the encoder and signaled to the decoder. When the flag is disabled, the inverse matrix is computed at the decoder.

According to yet another variant, camera parameters syntax data structure comprises 4 extrinsic matrix coefficients (EWtoCq[k]) of a quaternion representation of a rotation of the game engine virtual camera in a world coordinate system. In this variant, the rotation part of the extrinsic world to camera matrix is converted into 4 quaternion values that are signaled in the picture header instead of the 9 coefficients of rotation matrix. The quaternion values are then converted to rotation matrix as for instance described in the document “Quaternions and Rotation Sequences: A Primer with Applications to Orbits, Aerospace and Virtual Reality” by J. B. Kuipers (Chapter 5, Section 5.14 “Quaternions to Matrices”, pg. 125).

The syntax of the gaming camera parameters defined above is modified as below:

| | Descriptor |
|---|---|
| gaming_camera_data( ) { | |
| intrinsic_param_focal_flag | u(1) |
| intrinsic_param plane_flag | u(1) |
| extrinsic_param_rotation_flag | u(1) |
| ... | |
| if(extrinsic_param_rotation_flag) { | |
| for(k=0;k<4;k++){ | |
| EWtoCq [k] | FP |
| } | |
| } | |
| ... | |
| if(inv_extrinsic_param_rotation_flag) { | |
| for(k=0; k<4; j++) { | |
| ECtoWq [k] | FP |
| } | |
| } | |
| ... | |

EWtoCq[k]: These 4 coefficients represent the quaternion representation of the rotation part of the extrinsic world to camera matrix.
ECtoWq[k]: These 4 coefficients represent the quaternion representation of the rotation part of the extrinsic camera to world matrix.

According to at least one embodiment, the camera parameters provide information of an absolute position and absolute orientation of a game engine virtual camera capturing a picture. In a variant, the camera parameters provide information of a difference of position a game engine virtual camera between a picture and a previous picture and a difference of orientation of a game engine virtual camera between a picture and a previous picture. According to at least one embodiment, whether absolute or relative values are signaled is explicitely indicated by a flag or derived from the picture type, for instance the values are absolute of I pictures while the values are relative for P pictures. Thus, in a variant, the camera parameters syntax structure further comprises an indication that the camera parameters provide information of a difference of position a game engine virtual camera between a picture and a previous picture and a difference of orientation of a game engine virtual camera between a picture and a previous picture. In another variant, indication that the camera parameters provide information of a difference of position a game engine virtual camera between a picture and a previous picture and a difference of orientation of a game engine virtual camera between a picture and a previous picture is inferred from the picture type. In other words, the rotation and translation parameters may correspond to the extrinsic matrix coefficients as provided by the game engine (so, relatively to its 3D world coordinate system). In a variant embodiment, the extrinsic parameters which are provided do not represent the position of the camera relatively to the 3D world coordinate system but represent the rotations and translations relatively to the previous position of the virtual camera. A flag is coded for rotation and translation separately to indicate if the parameter coded is relative to the previous frame or an absolute value. Depending on this flag, the decoded rotation and translational parameters are treated on the decoder side. For example, if the flag is set, the current rotation parameters are determined by adding the decoded rotation parameter values to the previous frame absolute rotation parameter value.

For instance, this sub-section could be added:

```
gaming_camera_data( ) {
  ...
  relative_param_rotation_flag
  relative_param_translation_flag
  relative_param_focal_flag
  relative_param_plane_flag
  ...
  if(relative_param_rotation_flag) {
    for(j=0; j<3; j++) {
      for(k=0;k<3;k++){
        RelativeWtoCR [j][k]
      }
  }
  if(relative_param_translation_flag) {
    for(k=0;k<3;k++){
      RelativeWtoCT[k]
    }
  }
  if(relative_param_focal_flag) {
    RelativeIF0
    RelativeIF1
  }
  ...
}
```

Here, RelativeWtoCR [j][k] and RelativeWtoCT[k] do not represent the position, but the displacement relatively to the previous position. Similarly, RelativeIF0 and RelativeIF1 do not represent the focal length, but the difference relative to the previous focal length value. It is implied here that the absolute value of extrinsic and intrinsic parameters are required by the decoder to perform the decoding. This is controlled by sending an absolute value every few frames, typically every I-frame.

In a variant, the flag indicating whether the parameters are signaled relative to the previous frame or as absolute values is inferred based on the frame type. For example, absolute values are inferred for I-frame or start of GDR-frame.

In another variant, the above embodiments may be combined such that for a given frame n, the extrinsic parameters transmitted are relative to the 3D world position, and for the frame n+1, the extrinsic parameters transmitted are relative to the previous frame n.

In yet another variant of this embodiment, the camera position could be automatically initialized to 0 (no rotation, no translation) for instance for the I frame of a new GOP. The transmitted parameters for the following frame corresponding to a displacement relative to the previous frame.

In the above embodiments, we only considered one camera. In some applications, 2 or more cameras may be required. According to at least one embodiment, a syntax data element indicates whether one or more instances of one camera parameters syntax data structure are present in a bitstream. For instance, to render a 3D stereoscopic content, 2 cameras a required. Instead of transmitting the camera parameters for a unique camera as proposed above, a list of camera parameters is transmitted. These parameters can be absolute parameters, or one camera can be considered as the main camera with absolute parameters, the others camera parameters being provided relatively to this main camera.

Since the intrinsic camera parameters do not change that often, it may not be efficient to signal the flag and relative values in a picture header. According to at least one embodiment, at least one camera parameters syntax data element is added at sequence level wherein the at least one camera parameters syntax data element at sequence level comprising a first set of intrinsic camera parameters related to a field of view and to a far plane and a near plane. Advantageously, the at least one camera parameters syntax data structure at a picture level comprises the set of extrinsic matrix coefficients representing a rotation of the game engine virtual camera or a translation of the game engine virtual camera. In yet another variant, a syntax data element is added at sequence level that indicates an update of the at least one camera parameters syntax data structure representative of camera parameters at a sequence level or at picture level. In this embodiment, it is proposed to transmit intrinsic camera parameters relative to 3D world coordinates in the SPS syntax. Next, a flag is coded in the picture header indicating if there is a change. When this flag is set, only the difference is signaled. The intrinsic camera parameters are updated in the next SPS. As a variant to this embodiment, the intrinsic camera parameter may be alternatively signaled in the Picture Parameter Set (PPS).

### Additional Embodiments and Information

Various methods are described herein, and each of the methods comprises one or more steps or actions for achieving the described method. Unless a specific order of steps or actions is required for proper operation of the method, the order and/or use of specific steps and/or actions may be modified or combined. Additionally, terms such as “first”, “second”, etc. may be used in various embodiments to modify an element, component, step, operation, etc., for example, a “first decoding” and a “second decoding”. Use of such terms does not imply an ordering to the modified operations unless specifically required. So, in this example, the first decoding need not be performed before the second decoding, and may occur, for example, before, during, or in an overlapping time period with the second decoding.

Various methods and other aspects described in this application can be used to modify modules, for example, the inter prediction modules (270, 275, 375), of a video encoder 200 and decoder 300 as shown in FIG. 2 and FIG. 3. Moreover, the present aspects are not limited to VVC or HEVC, and can be applied, for example, to other standards and recommendations, and extensions of any such standards and recommendations. Unless indicated otherwise, or technically precluded, the aspects described in this application can be used individually or in combination.

Various numeric values are used in the present application. The specific values are for example purposes and the aspects described are not limited to these specific values.

Various implementations involve decoding. “Decoding,” as used in this application, may encompass all or part of the processes performed, for example, on a received encoded sequence in order to produce a final output suitable for display. In various embodiments, such processes include one or more of the processes typically performed by a decoder, for example, entropy decoding, inverse quantization, inverse transformation, and differential decoding. Whether the phrase “decoding process” is intended to refer specifically to a subset of operations or generally to the broader decoding process will be clear based on the context of the specific descriptions and is believed to be well understood by those skilled in the art.

Various implementations involve encoding. In an analogous way to the above discussion about “decoding”, “encoding” as used in this application may encompass all or part of the processes performed, for example, on an input video sequence in order to produce an encoded bitstream.

Note that the syntax elements as used herein are descriptive terms. As such, they do not preclude the use of other syntax element names.

The implementations and aspects described herein may be implemented as various pieces of information, such as for example syntax, that can be transmitted or stored, for example. This information can be packaged or arranged in a variety of manners, including for example manners common in video standards such as putting the information into an SPS, a PPS, a NAL unit, a header (for example, a NAL unit header, or a slice header), or an SEI message. Other manners are also available, including for example manners common for system level or application level standards such as putting the information into one or more of the following:
SDP(session description protocol), a format for describing multimedia communication sessions for the purposes of session announcement and session invitation, for example as described in RFCs and used in conjunction with RTP(Real-time Transport Protocol) transmission;
DASH MPD (Media Presentation Description) Descriptors, for example as used in DASH and transmitted over HTTP, a Descriptor is associated to a Representation or collection of Representations to provide additional characteristic to the content Representation;
RTP header extensions, for example as used during RTP streaming;
ISO Base Media File Format, for example as used in OMAF and using boxes which are object-oriented building blocks defined by a unique type identifier and length also known as ‘atoms’ in some specifications;
HLS (HTTP live Streaming) manifest transmitted over HTTP. A manifest can be associated, for example, to a version or collection of versions of a content to provide characteristics of the version or collection of versions.

The implementations and aspects described herein may be implemented in, for example, a method or a process, an apparatus, a software program, a data stream, or a signal. Even if only discussed in the context of a single form of implementation (for example, discussed only as a method), the implementation of features discussed may also be implemented in other forms (for example, an apparatus or program). An apparatus may be implemented in, for example, appropriate hardware, software, and firmware. The methods may be implemented in, for example, an apparatus, for example, a processor, which refers to processing devices in general, including, for example, a computer, a microprocessor, an integrated circuit, or a programmable logic device. Processors also include communication devices, for example, computers, cell phones, portable/personal digital assistants (“PDAs”), and other devices that facilitate communication of information between end-users.

Reference to “one embodiment” or “an embodiment” or “one implementation” or “an implementation”, as well as other variations thereof, means that a particular feature, structure, characteristic, and so forth described in connection with the embodiment is included in at least one embodiment. Thus, the appearances of the phrase “in one embodiment” or “in an embodiment” or “in one implementation” or “in an implementation”, as well any other variations, appearing in various places throughout this application are not necessarily all referring to the same embodiment.

Additionally, this application may refer to “determining” various pieces of information. Determining the information may include one or more of, for example, estimating the information, calculating the information, predicting the information, or retrieving the information from memory.

Further, this application may refer to “accessing” various pieces of information. Accessing the information may include one or more of, for example, receiving the information, retrieving the information (for example, from memory), storing the information, moving the information, copying the information, calculating the information, determining the information, predicting the information, or estimating the information.

Additionally, this application may refer to “receiving” various pieces of information. Receiving is, as with “accessing”, intended to be a broad term. Receiving the information may include one or more of, for example, accessing the information, or retrieving the information (for example, from memory). Further, “receiving” is typically involved, in one way or another, during operations, for example, storing the information, processing the information, transmitting the information, moving the information, copying the information, erasing the information, calculating the information, determining the information, predicting the information, or estimating the information.

It is to be appreciated that the use of any of the following “/”, “and/or”, and “at least one of”, for example, in the cases of “A/B”, “A and/or B” and “at least one of A and B”, is intended to encompass the selection of the first listed option (A) only, or the selection of the second listed option (B) only, or the selection of both options (A and B). As a further example, in the cases of “A, B, and/or C” and “at least one of A, B, and C”, such phrasing is intended to encompass the selection of the first listed option (A) only, or the selection of the second listed option (B) only, or the selection of the third listed option (C) only, or the selection of the first and the second listed options (A and B) only, or the selection of the first and third listed options (A and C) only, or the selection of the second and third listed options (B and C) only, or the selection of all three options (A and B and C). This may be extended, as is clear to one of ordinary skill in this and related arts, for as many items as are listed.

Also, as used herein, the word “signal” refers to, among other things, indicating something to a corresponding decoder. For example, in certain embodiments the encoder signals a quantization matrix for de-quantization. In this way, in an embodiment the same parameter is used at both the encoder side and the decoder side. Thus, for example, an encoder can transmit (explicit signaling) a particular parameter to the decoder so that the decoder can use the same particular parameter. Conversely, if the decoder already has the particular parameter as well as others, then signaling can be used without transmitting (implicit signaling) to simply allow the decoder to know and select the particular parameter. By avoiding transmission of any actual functions, a bit savings is realized in various embodiments. It is to be appreciated that signaling can be accomplished in a variety of ways. For example, one or more syntax elements, flags, and so forth are used to signal information to a corresponding decoder in various embodiments. While the preceding relates to the verb form of the word “signal”, the word “signal” can also be used herein as a noun.

As will be evident to one of ordinary skill in the art, implementations may produce a variety of signals formatted to carry information that may be, for example, stored or transmitted. The information may include, for example, instructions for performing a method, or data produced by one of the described implementations. For example, a signal may be formatted to carry the bitstream of a described embodiment. Such a signal may be formatted, for example, as an electromagnetic wave (for example, using a radio frequency portion of spectrum) or as a baseband signal. The formatting may include, for example, encoding a data stream and modulating a carrier with the encoded data stream. The information that the signal carries may be, for example, analog or digital information. The signal may be transmitted over a variety of different wired or wireless links, as is known. The signal may be stored on a processor-readable medium.

1. A method, comprising:
encoding a syntax data element indicating whether a camera parameters syntax structure is present in a bitstream; and
wherein responsive to the camera parameters syntax structure being present, the method further comprises:
encoding at least one camera parameters syntax data structure representative of camera parameters at a picture level, wherein the camera parameters provide information of a position, an orientation and characteristics of a game engine virtual camera capturing a picture.

2-13. (canceled)

14. The method of claim 1, wherein the camera parameters syntax structure further comprises an indication that inverse intrinsic matrix coefficients and inverse extrinsic matrix coefficients are computed at a decoder.

15-16. (canceled)

17. The method of claim 1, wherein the camera parameters syntax structure further comprises an indication that the camera parameters provide information of a difference of position a game engine virtual camera between a picture and a previous picture and a difference of orientation of a game engine virtual camera between a picture and a previous picture.

18. (canceled)

19. The method of claim 1, further comprising encoding at least one camera parameters syntax data element at sequence level, the at least one camera parameters syntax data element at sequence level comprising a first set of intrinsic camera parameters related to a field of view and to a far plane and a near plane.

20. The method of claim 19, further comprising encoding a syntax data element at sequence level indicating an update instance of the at least one camera parameters syntax data structure representative of camera parameters at a sequence level.

21. (canceled)

22. A method, comprising:
decoding a syntax data element indicating whether a camera parameters syntax structure is present in a bitstream; and
wherein responsive to the camera parameters syntax structure being present, the method further comprises:
decoding at least one camera parameters syntax data structure representative of camera parameters at a picture level, wherein the camera parameters provide information of a position, an orientation and characteristics of a game engine virtual camera capturing a picture.

23-34. (canceled)

35. The method of claim 22, wherein the camera parameters syntax structure further comprises an indication that inverse intrinsic matrix coefficients and inverse extrinsic matrix coefficients are computed at a decoder.

36-37. (canceled)

38. The method of claim 22, wherein the camera parameters syntax structure further comprises an indication that the camera parameters provide information of a difference of position a game engine virtual camera between a picture and a previous picture and a difference of orientation of a game engine virtual camera between a picture and a previous picture.

39. (canceled)

40. The method of claim 22, further comprising decoding at least one camera parameters syntax data element at sequence level, the at least one camera parameters syntax data element at sequence level comprising a first set of intrinsic camera parameters related to a field of view and to a far plane and a near plane.

41. The method of claim 40, further comprising decoding a syntax data element at sequence level indicating an update instance of the at least one camera parameters syntax data structure representative of camera parameters at a sequence level.

42-43. (canceled)

44. A video encoding device, comprising a processor configured to:
encode a syntax data element indicating whether a camera parameters syntax structure is present in a bitstream; and
wherein responsive to the camera parameters syntax structure being present, encode at least one camera parameters syntax data structure representative of camera parameters at a picture level, wherein the camera parameters provide information of a position, an orientation and characteristics of a game engine virtual camera capturing a picture.

45. A video decoding device, comprising a processor configured to:
decode a syntax data element indicating whether a camera parameters syntax structure is present in a bitstream; and
wherein responsive to the camera parameters syntax structure being present, decode at least one camera parameters syntax data structure representative of camera parameters at a picture level, wherein the camera parameters provide information of a position, an orientation and characteristics of a game engine virtual camera capturing a picture.

46.-50. (canceled)

51. The device of claim 44, wherein the camera parameters syntax structure further comprises an indication that inverse intrinsic matrix coefficients and inverse extrinsic matrix coefficients are computed at a decoder.

52. The device of claim 44, wherein the camera parameters syntax structure further comprises an indication that the camera parameters provide information of a difference of position a game engine virtual camera between a picture and a previous picture and a difference of orientation of a game engine virtual camera between a picture and a previous picture.

53. The device of claim 44, wherein the processor is configured to encode at least one camera parameters syntax data element at sequence level, the at least one camera parameters syntax data element at sequence level comprising a first set of intrinsic camera parameters related to a field of view and to a far plane and a near plane.

54. The device of claim 53, wherein the processor is configured to encode a syntax data element at sequence level indicating an update instance of the at least one camera parameters syntax data structure representative of camera parameters at a sequence level.

55. The device of claim 45, wherein the camera parameters syntax structure further comprises an indication that inverse intrinsic matrix coefficients and inverse extrinsic matrix coefficients are computed at a decoder.

56. The device of claim 45, wherein the camera parameters syntax structure further comprises an indication that the camera parameters provide information of a difference of position a game engine virtual camera between a picture and a previous picture and a difference of orientation of a game engine virtual camera between a picture and a previous picture.

57. The device of claim 45, wherein the processor is configured to dencode at least one camera parameters syntax data element at sequence level, the at least one camera parameters syntax data element at sequence level comprising a first set of intrinsic camera parameters related to a field of view and to a far plane and a near plane.

58. The device of claim 57, wherein the processor is configured to decode a syntax data element at sequence level indicating an update instance of the at least one camera parameters syntax data structure representative of camera parameters at a sequence level.
